(19) United States
(12) Patent Application Publication
(10) Pub. No.: US 2007/0129946 A1
(43) Pub. Date: Jun. 7, 2007

(54) High quality speech reconstruction for a dialog method and system

(76) Inventors: Changxue C. Ma, Barrington, IL (US); Yan M. Cheng, Inverness, IL (US); Tenkasi V. Ramabadran, Naperville, IL (US)

Correspondence Address: MOTOROLA, INC., 1303 EAST ALGONQUIN ROAD, IL01/3RD, SCHAUMBURG, IL, 60196, US

(21) Appl. No.: 11/294,964

(22) Filed: Dec. 6, 2005

(51) Int. Cl. G10L 15/14

(52) U.S. Cl. 704/256

(57) ABSTRACT

An electronic device (400) for speech dialog includes functions that receive (405, 205) a speech phrase that includes an instantiated variable (315), generate pitch and voicing characteristics (330) of the instantiated variable, and performs voice recognition (410, 220) of the instantiated variable to determine a most likely set of recognition acoustic states (335). A trained map (358) is established (115) that maps recognition feature vectors derived from training speech (105) to synthesis feature vectors derived from the same training speech (110). Recognition feature vectors that represent the most likely set of recognition acoustic states for the recognized instantiated variable are converted to a most likely set of synthesis acoustic states (420) in accordance with the map. The electronic device may generate (421, 440, 445) a synthesized value of the instantiated variable using the most likely set of synthesis acoustic states and the pitch and voicing characteristics extracted from the instantiated variable.

### CROSS-REFERENCE TO RELATED APPLICATIONS

The present application is related to U.S. patent application Ser. No. 11/118,670 entitled “Speech Dialog Method and System,” which is incorporated herein in its entirety by this reference.

### FIELD OF THE INVENTION

The present invention is in the field of speech dialog systems, and more specifically in the field of synthesizing confirmation phrases in response to input phrases spoken by a user.

### BACKGROUND

Current dialog systems often use speech as both input and output modalities. For example, a speech recognition function may be used to convert speech input to text and then a text to speech (TTS) function may use the text generated by the conversion as input to synthesize speech output. In many dialog systems, speech generated using TTS provides audio feedback to a user to solicit the user's confirmation to verify the result of the system's recognition analysis of the speech input. For example, in handheld communication devices, a user can use the speech input modality of a dialog system incorporated within the device for dialing a number based on a spoken name. The reliability of this application is improved when TTS is used to synthesize a response phrase giving the user the opportunity to confirm the system's correct analysis of the received speech input. Conventional response generation functions that employ TTS as described above, however, require the expenditure of a significant amount of time and resources to develop. This is especially true when multiple languages are involved. Moreover, TTS implemented dialog systems consume significant amounts of the limited available memory resources within the handheld communication device. The foregoing factors can create a major impediment to the world-wide deployment of multi-lingual devices using such dialog systems.

One alternative is to synthesize confirmation responses through the reconstruction of speech directly from features derived from the speech input or from a most likely set of acoustic states determined by the recognition process. The most likely set of acoustic states is determined during the speech recognition process through a comparison of the input speech with a set of trained speech models. This alternative can significantly traverse the cost issues noted above. Providing confirmation speech of acceptable quality in this manner presents significant challenges.

### BRIEF DESCRIPTION OF THE DRAWINGS

The present invention is illustrated by way of example and not limitation in the accompanying figures, in which like references indicate similar elements, and in which:

FIG. 1 is a flow chart that shows a model and map training process for a speech dialog method in accordance with some embodiments of the present invention;

FIG. 2 is a flow chart that shows a speech dialog process in accordance with some embodiments of the present invention;

FIG. 3 is a diagram of an analysis of an exemplary speech phrase in accordance with some embodiments of the present invention; and

FIG. 4 is a block diagram of an electronic device that performs speech dialog in accordance with some embodiments of the present invention.

### DETAILED DESCRIPTION OF THE DRAWINGS

Before describing in detail the particular embodiments of speech dialog systems in accordance with the present invention, it should be observed that the embodiments of the present invention reside primarily in combinations of method steps and apparatus components related to speech dialog systems. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

It will also be understood that the terms and expressions used herein have the ordinary meaning as is accorded to such terms and expressions with respect to their corresponding respective areas of inquiry and study except where specific meanings have otherwise been set forth herein. In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

A “set” as used in this document may mean an empty set. The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, source code, object code, a shared library/dynamic load library and/or other sequence of instructions designed for execution on a computer system.

Related U.S. patent application Ser. No. 11/118,670 entitled “Speech Dialog Method and System” discloses embodiments of a speech dialog method and device for performing speech recognition on received speech and for generating a confirmation phrase from the most likely acoustic states derived from the recognition process. This represents an improvement over past techniques that use TTS techniques for generating confirmation phrases in response to input speech.

The perceived quality of a synthesized confirmation phrase generated directly from features extracted from input speech or from the most likely set of acoustic states as determined from a recognition process can vary significantly depending upon the manner in which the speech is mathematically represented (e.g., which features are extracted) and the manner by which it is then synthesized. For example, some features that may be mathematically extracted from input speech are better suited to distinguishing elements of speech in a manner similar to the way the human ear perceives speech. Thus, they tend to be better suited to the speech recognition function of a dialog system than they are to the speech synthesis function. Moreover, these types of extracted features are typically used to train speech models over a large number of speakers so that a recognition function employing the trained models can recognize speech over a broad range of speakers and speaking environments. This renders speech reconstruction from a most likely set of acoustic states, derived from such broadly trained models during the recognition process, even less desirable.

Likewise, certain types of features can be extracted from a received speech signal that are better suited to modeling speech as it is generated by the human vocal tract rather than the manner in which the speech is discerned by the ear. Using vectors consisting of these synthesis type feature parameters to generate speech tends to produce more normal sounding speech than does the use of recognition type feature parameters. On the other hand, synthesis type feature parameters tend not to be very stable when averaged over a broad number of speakers and therefore are less advantageous for use in speech recognition. Thus, it would be desirable to implement a speech dialog method and device that employs vectors of recognition type feature parameters for performing the recognition function, and vectors of synthesis type feature parameters for generating the appropriate confirmation phrase back to the user, rather than using just one type of feature parameter and thus disadvantaging one process over the other.

A speech dialog device and method in accordance with embodiments of the invention can receive, for example, an input phrase that constitutes both a non-variable segment and an instantiated variable. For the instantiated variable, the recognition process can be used to determine a most likely set of acoustic states in the form of recognition feature vectors from a set of trained speech models. This most likely set of recognition feature vectors can then be applied to a map to determine a most likely set of synthesis feature vectors that can also represent the most likely set of acoustic states determined for the instantiated variable (assuming that the recognition process was accurate in its recognition of the input speech). The synthesis feature vectors can then be used to synthesize the variable as part of a generated confirmation phrase. For a non-variable segment that is associated with the instantiated variable of the input phrase, the recognition process can identify the non-variable segment and determine an appropriate response phrase to be generated as part of the confirmation phrase. Response phrases can be pre-stored acoustically in any form suitable to good quality speech synthesis, including using the same synthesis type feature parameters as those used to represent the instantiated variable for synthesis purposes. In this way, both the recognition and synthesis functions can be optimized for a dialog system rather than compromising one function in favor of the other.

As part of a dialog process, it also may be desirable for the dialog method or device to synthesize a response phrase to a received speech phrase that includes no instantiated variable, such as “Please repeat the name,” under circumstances such as when the recognition process was unable to determine a close enough match between the input speech and the set of trained speech models to meet a certain metric to ensure reasonable accuracy. A valid user input response to such a synthesized response may include only a name, and no non-variable segment such as a command. In an alternate example, the input speech phrase from a user could be “Email the picture to John Doe”. In this alternate example, “Email” would be a non-variable segment, “picture” is an instantiated variable of type <email object>, and “John Doe” is an instantiated variable of the type <dialed name>.

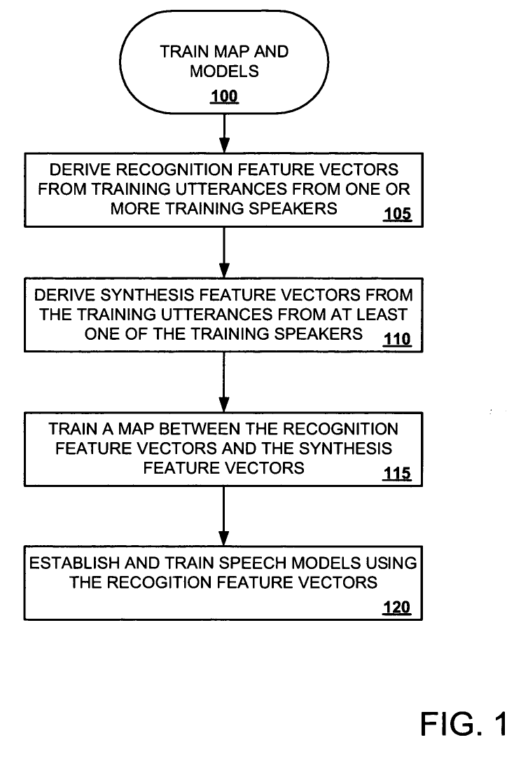

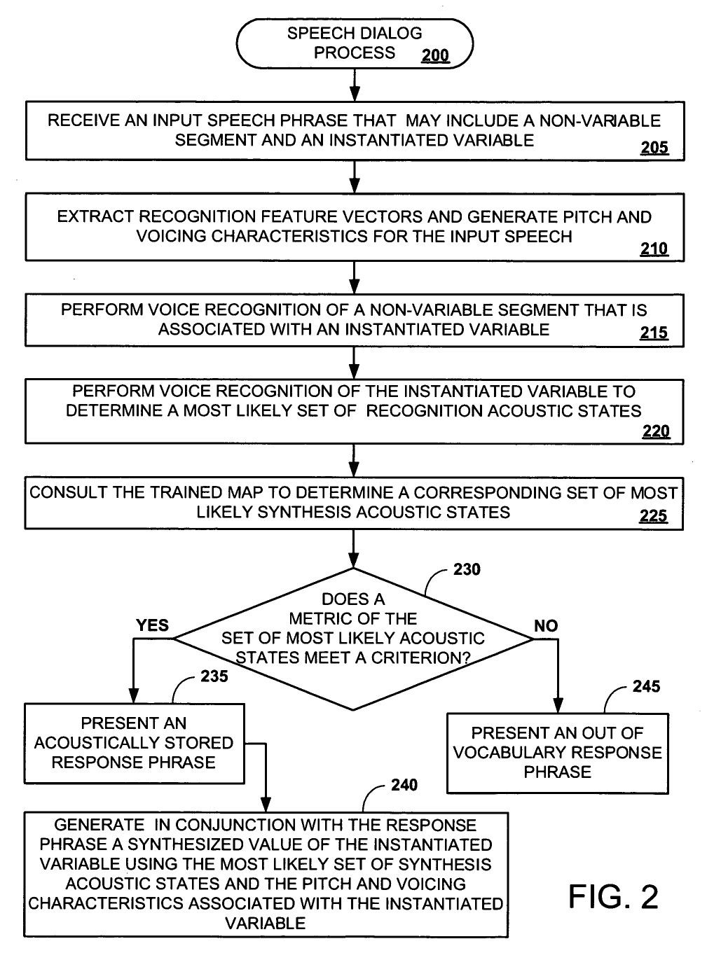

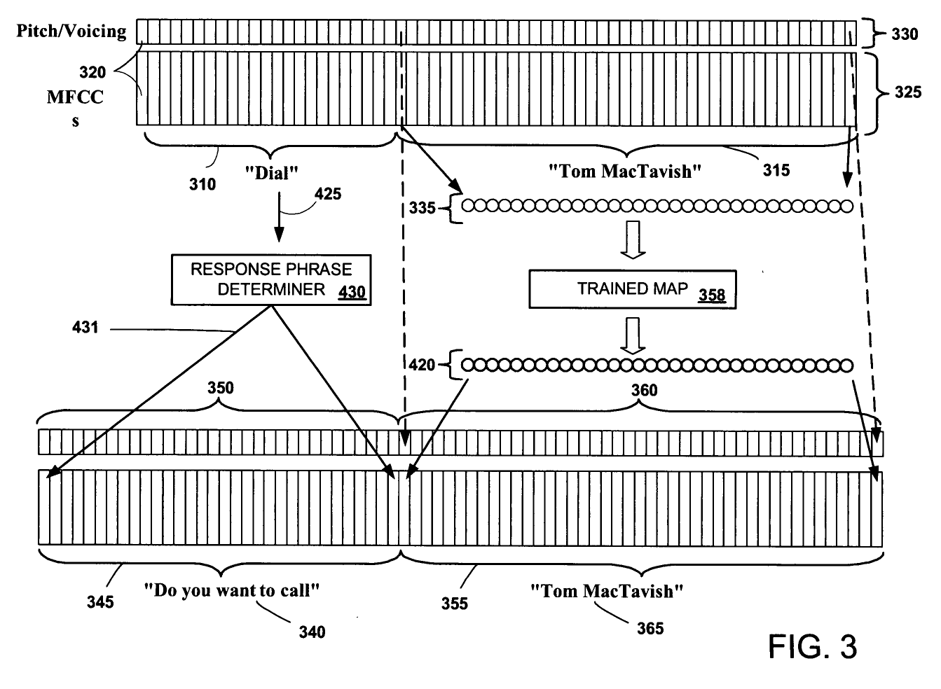

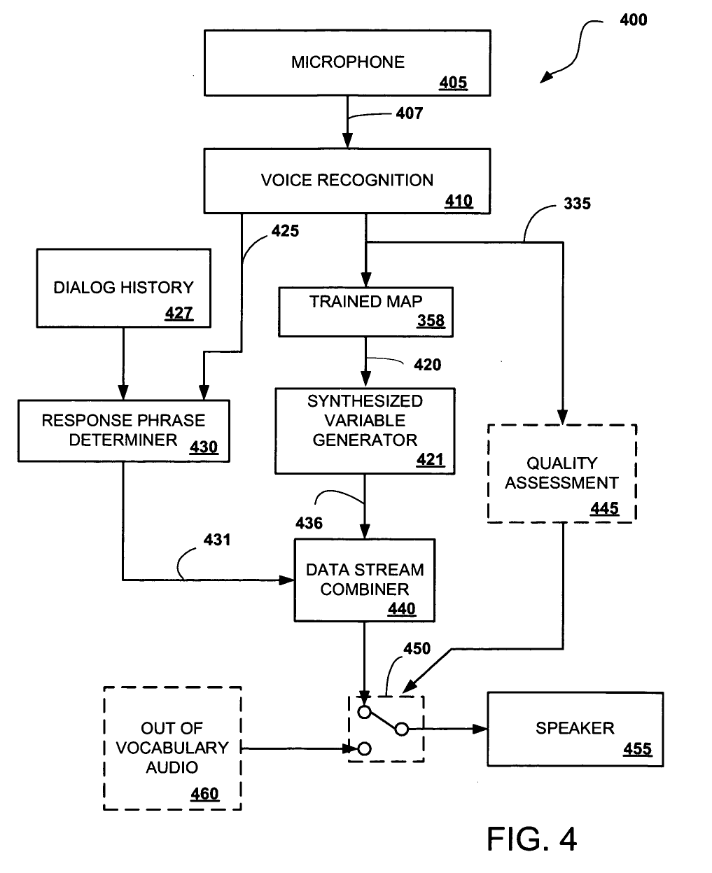

The following description of some embodiments of the present invention makes reference to FIGS. 1 and 2, where a flow chart for a ‘Train Map and Models’ process 100 (FIG. 1) and a ‘Speech Dialog Process’ 200 (FIG. 2) illustrate some steps of a method for speech dialog. Further reference will be made to FIG. 3 in which a diagram illustrates an example of an input speech phrase processed in accordance with the processes of FIGS. 1 and 2 received from a user, and FIG. 4 in which a block diagram of an embodiment of an electronic device 400 is shown that can perform the processes of FIGS. 1 and 2 and the analysis of FIG. 3.

At step 105 (FIG. 1) of the ‘Train Map and Models’ process 100, recognition feature vectors are derived from training speech utterances gathered from one or more speakers. Some or all of these recognition feature vectors can be used to train speech models as well as the map. The recognition features can be, for example, Mel-frequency cepstrum coefficients (MFCCs). It will be appreciated that feature vectors made up of MFCCs are particularly suited for application to the recognition process for a number of reasons. One is that they tend to provide stable distributions that can be averaged over numerous training speakers and are therefore able to reflect the broad variations that can be expected from one speaker to another for the same words or sounds. Another is that MFCCs are also suitable for use in conjunction with hidden Markov models (HMMs), which are commonly used to model speech sounds and words for purposes of speech recognition. Finally, the features of the speech represented by MFCCs provide readily discernable differences in various speech sounds. It will also be appreciated that the more speakers that are used to generate training speech utterances, the more general are the speech models trained therewith. Those of skill in the art will appreciate, however, that the recognition feature vectors can be made up of any speech parameters that are suited for optimal speech recognition.

At step 110, synthesis feature vectors are also derived from the same training speech uttered by one or more of the training speakers. The synthesis feature vectors can be generated at the same frame rate as the recognition feature vectors such that there is a one-to-one correspondence between the two sets of feature vectors (i.e., recognition and synthesis) for a given training utterance of a given speaker. Thus, for at least one training speaker, his or her utterances have a set of both recognition feature vectors and synthesis feature vectors, with each feature vector having a one-to-one correspondence with a member of the other set as they both represent the same sample frame of the training speech utterance for that speaker. These synthesis feature vectors, along with their corresponding recognition feature vectors, can be used to train the map. Those of skill in the art will recognize that these synthesis feature vectors can be made up of coefficients that are more suited to speech synthesis than recognition. An example of such parameters includes line spectrum pairs (LSP) coefficients, which are compatible for use with a vocal tract model of speech synthesis such as linear prediction coding (LPC). It will be appreciated that deriving the recognition features (e.g., MFCCs) and the synthesis features (e.g., the LSPs) from the training utterances of just one training speaker may be preferable because the quality of speech synthesis is not necessarily improved by averaging the synthesis feature vectors over many speakers as is the case for recognition.

At step 115, a mapping between recognition and synthesis feature vectors is established and trained using the sets of corresponding recognition and synthesis feature vectors as derived in steps 105 and 110. It will be appreciated that there are a number of possible techniques by which this can be accomplished. For example, vector quantization (VQ) can be employed to compress the feature data and to first generate a codebook for the recognition feature vectors using conventional vector quantization techniques. One such technique clusters or partitions the recognition feature vectors into distinct subsets by iteratively determining their membership in one of the clusters or partitions based on minimizing their distance to the centroid of a cluster. Thus, each cluster or partition subset is identified by a mean value (i.e., the centroid) of the cluster. The mean value of each cluster is then associated with an index value in the VQ codebook and represents all of the feature vectors that are members of that cluster. One way to train the map is to search the training database (i.e., the two corresponding sets of feature vectors derived from the same training utterances) for the recognition feature vector that is the closest in distance to the centroid value for each entry in the codebook. The synthesis feature vector that corresponds to that closest recognition feature vector is then stored in the mapping table for that entry.

As will be seen later, the most likely set of recognition feature vectors determined for an instantiated variable of input speech during the recognition process can be converted to a most likely set of synthesis feature vectors based on this mapping. For each of the most likely set of recognition feature vectors, the map table is searched for the entry corresponding to the centroid value closest to each of the most likely set of recognition feature vectors. The synthesis feature vector from the training database that has been mapped to that entry then becomes the corresponding synthesis feature vector for the most likely set of synthesis feature vectors that can be used to generate the response phrase.

Another possible method for training the map involves a more statistical approach where a Gaussian mixture model (GMM) is employed to model the conversion between the most likely set of recognition feature vectors and the most likely set of synthesis feature vectors. In an embodiment, the training recognition feature vectors are not coded as a set of discrete partitions, but as an overlapping set of Gaussian distributions, the mean of each Gaussian distribution being analogous to the cluster mean or the centroid value in the VQ table described above. The probability density of a recognition vector x in a GMM is given by

$$p ( x ) = {\sum }_{i = 1}^{m} {α}_{i} N ( x ; {μ}_{i} , {\sum }_{i} )$$

where m is the number of Gaussians, αᵢ≧0 is the weight corresponding to the i^{th} Gaussian with

$${\sum }_{i = 1}^{m} {α}_{i} = 1$$

and N(•) is a p-variate Gaussian distribution defined as

$$N ( x ; μ , Σ ) = \frac{1}{{( 2 π )}^{p / 2}} {\vert Σ \vert}^{- 1 / 2} exp [ - \frac{1}{2} {( x - μ )}^{T} {Σ}^{- 1} ( x - μ ) ]$$

with μ being the p×1 mean vector and Σ being the p×p covariance matrix.

Thus, when performing a conversion for each member x of the most likely set of recognition feature vectors, this technique does not simply look only for the mean to which x is closest, then finding the converted most likely synthesis vector to be the corresponding training synthesis feature vector associated with that mean. Rather, this statistical technique finds all of the joint probability densities p(x,i) of each of the most likely set of recognition feature vectors x being associated with each of the Gaussian distributions, forms conditional probability densities p(x,i)/p(x) and uses the conditional probability densities to weight the training synthesis feature vectors corresponding to the GMM means to establish the most likely synthesis feature vector.

Thus, in one embodiment the most likely synthesis feature vector y converted from the most likely recognition feature vector x is given by the weighted average

$$y = {\sum }_{i = 1}^{m} \frac{p ( x , i )}{p ( x )} {y}_{i}$$

where p(x,i)=αᵢN(x,μᵢ,Σᵢ) and the yᵢ's i=1 p(X) represent the training synthesis feature vectors corresponding to the mean vectors in the GMM. The training synthesis feature vector yᵢ corresponding to the GMM mean μₗ can be found by identifying the training recognition feature vector closest to the mean or the training recognition feature vector with the highest joint probability density p(x,i) and selecting the corresponding training synthesis feature vector. The GMM model can be trained using the well-known expectation and maximization (EM) algorithm from the set of recognition feature vectors extracted from the training speech. While this embodiment is a bit more complex, it provides improved speech synthesis quality. This mapping technique accounts for the variances in the distributions as well as closeness to the means. It will be appreciated that the statistical model of the conversion may be applied in a number of different ways.

At step 120, speech models are established and then trained in accordance with the recognition feature data for the training utterances. As previously mentioned, these models can be HMM's, which work well with the features of speech represented by the recognition feature parameters in the form of MFCCs. Techniques for modeling speech using HMMs and recognition feature vectors such as MFCCs extracted from training utterances are known to those of skill in the art. It will be appreciated that these models can be trained using the speech utterances of many training speakers.

At step 205 of a ‘Speech Dialog Process’ 200 (FIG. 2), an input speech phrase that is uttered by a user during a dialog is received by a microphone 405 (FIG. 4) of the electronic device 400. The received speech phrase is converted to a sampled digital electrical signal 407 by the electronic device 400 using a conventional technique. The speech phrase can be, for example, a request phrase that includes an instantiated variable such as a name, and can further comprise a non-variable segment such as a command. In the example of a received speech phrase as illustrated in FIG. 3, the input speech phrase from a user is “Dial Tom MacTavish”. In this input speech phrase, “Dial” is a word that is a non-variable segment or portion 310 of the input phrase and “Tom MacTavish” is a name that is an instantiated variable portion 315 of the input phrase (i.e., it is a particular value of a variable). The non-variable segment 310 in this example is a command <Dial>, and the instantiated variable of this example has a variable type that is <dialed name>. As previously mentioned, the speech phrase may alternatively include no non-variable segments or more than one non-variable segment, and may include more than one instantiated variable.

At step 210 (FIG. 2), a voice recognition function 410 (FIG. 4) of the electronic device 400 processes the digitized electronic signal of the received speech phrase over regular intervals 320 (FIG. 3), such as 10 milliseconds, to extract recognition feature parameters in the form of recognition feature vectors 325 from the received speech phrase. As previously mentioned, these recognition feature vectors may be made up of MFCCs or they may be feature vectors of another conventional (or non-conventional) type that are suitable for use in the speech recognition process. Pitch and voicing characteristics 315 which are not otherwise reflected in the information represented by the feature vector coefficients are also extracted and stored.

At steps 215, 220 (FIG. 2), the voice recognition function 410 (FIG. 4) selects a set of acoustic states from the stored models that is the most likely to be representative of the non-variable segment and the instantiated variable respectively. These most likely acoustic states are selected based on a comparison between the feature vectors derived from the instantiated variable and the non-variable segment of the received speech phrase, and the models. The electronic device 400 stores the mathematical models that were established and trained in step 120 of FIG. 1 in a conventional manner. As previously mentioned, speech models can take the form of any known speech modeling technique suitable for speech recognition, such as a series of HMM. There may be more than one set of HMMs, such as one for non-variable segments and one for each of several types of variables, or the HMMs may be a combined model for all types of variables and non-variable segments.

The most probable set of acoustic states selected by the recognition function for a non-variable segment determines a value 425 (FIGS. 3, 4), which identifies the non-variable segment as one of a finite set of possible words or phrases. Determining this value completes the voice recognition process for the non-variable segment at step 215 (FIG. 2). In accordance with some embodiments, a response phrase determiner 430 (FIGS. 3, 4) determines an appropriate response phrase using the identified value 425 of the non-variable segment (when one exists in the voice phrase). The determination of the response phrase can be a simple map between a set of possible values 425 and a set of possible response phrases. The determination of a response phrase can also be context influenced if the determination is made in conjunction with a dialog history generated by a dialog history function 427 (FIG. 4).

Thus, in the example shown in FIG. 3, the non-variable value <Dial> has been recognized and identified as value 425, and this non-variable segment value may be used with or without a dialog history to determine that audio for a response phrase “Do you want to call” 340 is to be generated. In an embodiment, this determination function is performed by response phrase determiner 430, FIGS. 3, 4. In an embodiment, a set of synthesis feature vectors for each response phrase associated with one of the finite number of possible non-variable segment values is pre-stored in the electronic device 400. Appropriate pitch and voicing values are also pre-stored in association with each such response phrase. The stored information for each phrase can be used to generate a digital audio signal 331 (FIG. 4) for the response phrase by conventional voice synthesis techniques appropriate to the type of synthesis feature vectors and the form of the pitch and voicing characteristic information used.

The most likely set of acoustic states determined and output by the recognition function 410 (FIG. 4) for an instantiated variable corresponds to the acoustic states 335 (FIG. 3, 4), which most likely represent the variable segment as determined through a comparison with the models. The determination of this set of states completes the voice recognition process for the variable segment at step 220 (FIG. 2). The trained map 358 (FIG. 3, 4) is then consulted as part of step 225 of FIG. 2 to determine a most likely set of synthesis acoustic states that are converted from the most likely set of recognition acoustic states 335 in accordance with the map as previously described. The correspondence or mapping between these states is determined during step 115 of FIG. 1 as previously discussed. In the example of FIG. 3, the most likely set of recognition states, as determined by the voice recognition function 410 for the recognized instantiated variable “Tom MacTavish” are shown as a series of acoustic states 335 (FIG. 3) and as an output 335 from the voice recognition function 410 (FIG. 4). The corresponding most likely set of synthesis acoustic states determined from map 358 (FIGS. 3, 4) is represented by states 420 (FIG. 3) and output 420 (FIG. 4).

The set of synthesis acoustic states for the response phrase “Do you want to call?” 340 in the example of FIG. 3 is a set of synthesis acoustic vectors 345 and associated pitch and voicing characteristics 350. This response phrase is associated with the non-variable segment value for the command <Dial>. In other embodiments, digitized audio samples of the response phrases can be pre-stored and used directly to generate the digital audio signal 431 for the determined response phrase. In an embodiment, the pre-stored acoustic states for generating the response phrase can be of feature vectors 345 having coefficients that are more suited for speech synthesis, such as LSP coefficients for use in conjunction with LPC speech synthesis.

In the case of the instantiated variable, the most likely set of recognition acoustic states 335 (FIG. 3) as determined from the recognition process are converted to a most likely set of synthesis acoustic states 420 represented by a most likely set of synthesis feature vectors 355 (FIG. 3) comprised of speech parameters such as LSP coefficients. LSP coefficients are better suited for generating quality speech using the LPC speech synthesis. The map 358 can be in the form of a mapping table or as a statistical model as previously discussed and can be trained using a number of approaches. Thus, the electronic device 400 (FIG. 4) further includes a synthesized variable generator 421 that generates a digitized audio signal 436 of the recognized instantiated variable from the set of most likely synthesis feature vectors obtained from the map. It will be appreciated that pitch and voicing characteristics 360 (FIG. 3) for synthesizing the instantiated variable can be derived from the input speech as illustrated in FIG. 3. The duration of the pitch and voicing characteristics can be expanded or contracted during the alignment to match the synthesis feature vectors 355 generated from the most likely set of acoustic states. A data stream combiner 440 (FIG. 4) sequentially combines the digitized audio signals of the response phrase and the synthesized instantiated variable in an appropriate order to achieve the entire confirmation response. During the combining process, the pitch and voicing characteristics of the response phrase may be modified from those stored in order to blend well with those used for the synthesized instantiated variable.

In the example illustrated in FIG. 3, when the selected most likely set of acoustic states is for the value of the called name that is Tom MacTavish, the presentation of the response phrase and the synthesized instantiated variable, “Tom MacTavish” 365 would typically be quite understandable to the user in most circumstances, allowing the user to affirm the correctness of the selection. On the other hand, when the selected most likely set of acoustic states is for a value of the called name that is, for example Tom Lynch, the presentation of the response phrase and the synthesized instantiated variable for “Tom Lynch” would typically be harder for the user to mistake as the desired Tom MacTavish. It will not only be the wrong value selected and used, but it will be presented to the user in most circumstances with wrong pitch and voicing characteristics, allowing the user to more easily disaffirm the selection. Essentially, by using the pitch and voicing of the received phrase, differences are highlighted between a value of a variable that is correct and a value of the variable that is phonetically close but incorrect.

In some embodiments, an optional quality assessment function 445 (FIG. 4) of the electronic device 400 determines a quality metric of the most likely set of acoustic states, and when the quality metric meets a criterion, the quality assessment function 445 controls a selector 450 (FIG. 4) to couple the digital audio signal output of the data stream combiner to a speaker function 455 (FIG. 4) that converts the digital audio signal to an analog signal and uses it to drive a speaker. The determination and control performed by the quality assessment function 445 is embodied as optional decision step 230 (FIG. 2), at which a determination is made whether a metric of the most likely set of acoustic vectors meets a criterion. The aspect of generating the response phrase digital audio signal 431 (FIG. 4) by the response phrase determiner 430 is embodied as step 235 (FIG. 2), at which an acoustically stored response phrase is presented. The aspect of generating a digitized audio signal 436 of a synthesized instantiated variable using the most likely set of acoustic states and the pitch and voicing characteristics of the instantiated variable is embodied as step 240 (FIG. 2).

In those embodiments in which the optional quality assessment function 445 determines a quality metric of the most likely set of acoustic states, when the quality metric does not meet the criterion, the quality assessment function 445 controls an optional selector 450 to couple a digitized audio signal from an out-of-vocabulary (OOV) response audio function 460 to the speaker function 455 that presents a phrase to a user at step 245 (FIG. 2) that is an OOV notice. For example, the OOV notice may be “Please repeat your last phrase”. In the same manner as for the response phrases, this OOV phrase may be stored as digital samples or acoustic vectors with pitch and voicing characteristics, or similar forms. In embodiments not using a metric to determine whether to present the OOV phrase, the output of the data stream combiner function 440 is coupled directly to the speaker function 455, and steps 230 and 245 (FIG. 2) are eliminated.

The metric that is used in those embodiments in which a determination is made as to whether to present an OOV phrase may be a metric that represents a confidence that a correct selection of the most likely set of acoustic states has been made. For example, the metric may be a metric of a distance between the set of acoustic vectors representing an instantiated variable and the selected most likely set of acoustic states.

The embodiments of the speech dialog methods 100, 200 and electronic device 400 described herein may be used in a wide variety of electronic apparatus such as, but not limited to, a cellular telephone, a personal entertainment device, a pager, a television cable set top box, an electronic equipment remote control unit, a portable or desktop or mainframe computer, or an electronic test equipment. The embodiments provide a benefit of less development time and require fewer processing resources than prior art techniques that involve speech recognition, a determination of a text version of the most likely instantiated variable and the synthesis from text to speech for the synthesized instantiated variable. These benefits are partly a result of avoiding the development of the text to speech software systems for synthesis of the synthesized variables for different spoken languages for the embodiments described herein.

It will be appreciated the speech dialog embodiments described herein may be comprised of one or more conventional processors and unique stored program instructions that control the one or more processors to implement, in conjunction with certain non-processor circuits, some, most, or all of the functions of the speech dialog embodiments described herein. The unique stored programs made be conveyed in a media such as a floppy disk or a data signal that downloads a file including the unique program instructions. The non-processor circuits may include, but are not limited to, a radio receiver, a radio transmitter, signal drivers, clock circuits, power source circuits, and user input devices. As such, these functions may be interpreted as steps of a method to perform accessing of a communication system. Alternatively, some or all functions could be implemented by a state machine that has no stored program instructions, in which each function or some combinations of certain of the functions are implemented as custom logic. Of course, a combination of the two approaches could be used. Thus, methods and means for these functions have been described herein.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. Some aspects of the embodiments are described above as being conventional, but it will be appreciated that such aspects may also be provided using apparatus and/or techniques that are not presently known. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method for speech dialog, comprising:
receiving an input speech phrase that includes an instantiated variable;
extracting pitch and voicing characteristics for the instantiated variable;
performing voice recognition of the instantiated variable to determine a most likely set of recognition acoustic states;
converting the most likely set of recognition acoustic states to a most likely set of synthesis acoustic states; and
generating a synthesized value of the instantiated variable using the most likely set of synthesis acoustic states and the extracted pitch and voicing characteristics.

2. The method for speech dialog according to claim 1, wherein said performing voice recognition of the instantiated variable comprises:
extracting acoustic characteristics in the form of recognition feature vectors of the instantiated variable; and
comparing the extracted acoustic characteristics to a mathematical model of stored lookup values to determine a most likely set of the extracted recognition feature vectors representing the most likely set of recognition acoustic states.

3. The method for speech dialog according to claim 2, said converting further comprising:
deriving recognition feature vectors from training speech uttered by at least one speaker;
deriving synthesis feature vectors from the training speech uttered by the at least one speaker, each of the derived synthesis vectors corresponding on a one-to-one basis to one of the derived recognition vectors;
mapping a plurality of subsets of the derived recognition feature vectors to a most likely set of synthesis feature vectors, and
for each of the most likely set of recognition feature vectors:
determining the probability that the most likely recognition feature vector belongs in one or more of the subsets; and
selecting a most likely synthesis feature vector based on the determined probability and the mapping.

4. The method for speech dialog according to claim 3, wherein the extracted and derived recognition feature vectors comprise Mel-frequency cepstrum coefficients and the extracted and derived synthesis feature vectors comprise linear prediction coding compatible coefficients.

5. The method for speech dialog according to claim 1, wherein said generating the synthesized value of the instantiated variable is performed when a metric of the most likely set of recognition acoustic states meets a criterion, and further comprising presenting an acoustically stored out-of-vocabulary response phrase when the metric of the most likely set of recognition acoustic states fails to meet the criterion.

6. The method for speech dialog according to claim 1, wherein the speech phrase further includes a non-variable segment that is associated with the instantiated variable, further comprising:
performing voice recognition of the non-variable segment; and
presenting an acoustically stored response phrase based on the recognized non-variable segment.

7. The method for speech dialog according to claim 3, wherein said mapping further comprises
creating the subsets of extracted recognition feature vectors through vector quantization;
establishing a vector quantization table comprising a plurality of entries, each of the entries comprising a centroid for a different one of the subsets; and
determining the most likely synthesis feature vector for each of the entries, comprising:
selecting an appropriate one of the derived recognition feature vectors from the subset corresponding to each entry; and
associating the entry with the derived synthesis feature vector that corresponds to the appropriate recognition feature vector on a one-to-one basis.

8. The method for speech dialog according to claim 7, wherein the selected appropriate one of the derived recognition feature vectors is the derived recognition feature vector of the subset that is closest to the centroid.

9. The method for speech dialog according to claim 3, wherein said mapping further comprises:
modeling the derived recognition feature vectors such that each of the subsets is a statistical distribution characterized by a mean vector, a covariance matrix and a non-negative weight; and
determining the most likely synthesis feature vector that corresponds to each of the most likely set of recognition feature vectors based on the probability that each of the set of most likely recognition feature vectors is in any one of the subsets.

10. The method for speech dialog according to claim 9, wherein said determining the most likely synthesis feature vector further comprises:
computing a weight for each of the set of most likely recognition feature vectors, each weight corresponding to the probability the most likely synthesis feature vector is in that one of the subsets; and
applying the computed weights for each of the subsets to the derived synthesis feature vectors each of which corresponds to the derived recognition feature vectors comprising each of the subsets to obtain the converted most likely synthesis feature vector.

11. An electronic device for speech dialog, comprising:
means for receiving an input speech phrase that includes an instantiated variable;
means for extracting pitch and voicing characteristics for the instantiated variable;
means for performing voice recognition of the instantiated variable to determine a most likely set of recognition acoustic states;
means for converting the most likely set of recognition acoustic states to a most likely set of synthesis acoustic states; and
means for generating a synthesized value of the instantiated variable using the most likely set of synthesis acoustic states and the extracted pitch and voicing characteristics.

12. The electronic device for speech dialog according to claim 11, wherein said means for performing voice recognition of the instantiated variable comprises:
means for extracting acoustic characteristics in the form of recognition feature vectors of the instantiated variable; and
means for comparing the extracted acoustic characteristics to a mathematical model of stored lookup values to determine a most likely set of the extracted recognition feature vectors representing the most likely set of recognition acoustic states.

13. The electronic device for speech dialog according to claim 12, said means for converting further comprising:
means for deriving recognition feature vectors from training speech uttered by at least one speaker;
means for deriving synthesis feature vectors from the training speech uttered by the at least one speaker, each of the derived synthesis vectors corresponding on a one-to-one basis to one of the derived recognition vectors;
means for mapping a plurality of subsets of the derived recognition feature vectors to a most likely set of synthesis feature vectors, and
means for determining the probability that each of the most likely set of recognition feature vectors belongs in one or more of the subsets; and
means for selecting a most likely synthesis feature vector for each of the most likely set of recognition feature vectors based on the determined probability and the mapping.

14. The electronic device for speech dialog according to claim 13, wherein said means for mapping further comprises
means for creating the subsets of extracted recognition feature vectors through vector quantization;
means for establishing a vector quantization table comprising a plurality of entries, each of the entries comprising a centroid for a different one of the subsets; and
means for determining the most likely synthesis feature vector for each of the entries, comprising:
means for selecting an appropriate one of the derived recognition feature vectors from the subset corresponding to each entry; and
means for associating the entry with the derived synthesis feature vector that corresponds to the appropriate recognition feature vector on a one-to-one basis.

15. The electronic device for speech dialog according to claim 14, wherein the selected appropriate one of the derived recognition feature vectors is the derived recognition feature vector of the subset that is closest to the centroid.

16. The electronic device for speech dialog according to claim 13, wherein said means for mapping further comprises:
means for modeling the derived recognition feature vectors such that each of the subsets is a statistical distribution characterized by a mean vector, a covariance matrix and a non-negative weight; and
means for determining the most likely synthesis feature vector that corresponds to each of the most likely set of recognition feature vectors based on the probability that each of the set of recognition feature vectors is in any one of the subsets.

17. The electronic device for speech dialog according to claim 11, wherein said means for determining the most likely synthesis feature vector further comprises:
means for computing a weight for each of the set of most likely recognition feature vectors, each weight corresponding to the probability the most likely synthesis feature vector is in that one of the subsets; and
means for applying the computed weights for each of the subsets to the derived synthesis feature vectors each of which corresponds to the derived recognition feature vectors comprising each of the subsets to obtain the converted most likely synthesis feature vector.

18. A media that includes a set of stored program instructions, comprising:
a function for receiving an input speech phrase that includes an instantiated variable;
a function for extracting pitch and voicing characteristics for the instantiated variable;
a function for performing voice recognition of the instantiated variable to determine a most likely set of recognition acoustic states;
a function for converting the most likely set of recognition acoustic states to a most likely set of synthesis acoustic states; and
a function for generating a synthesized value of the instantiated variable using the most likely set of synthesis acoustic states and the extracted pitch and voicing characteristics.

19. The media that includes a set of stored program instructions according to claim 18, wherein said function for performing voice recognition of the instantiated variable comprises:
a function for extracting acoustic characteristics in the form of recognition feature vectors of the instantiated variable; and
a function for comparing the extracted acoustic characteristics to a mathematical model of stored lookup values to determine a most likely set of the extracted recognition feature vectors representing the most likely set of recognition acoustic states.

20. The media that includes a set of stored program instructions according to claim 19, said function for mapping further comprising:
a function for modeling the derived recognition feature vectors such that each of the subsets is a statistical distribution characterized by a mean vector, a covariance matrix and a non-negative weight; and
a function for determining the most likely synthesis feature vector that corresponds to each of the most likely set of recognition feature vectors based on the probability that each of the set of most likely recognition feature vectors is in any one of the subsets.
